(19) United States
(12) Patent Application Publication
(10) Pub. No.: US 2013/0301271 A1
(43) Pub. Date: Nov. 14, 2013

(54) Optimization of a Conical Lens/Cap System for Producing a Standard Light Plane

(71) Applicants: Wilfried Bittner, Tsuen Wan (HK); Thomas Zimmermann, Muenchen (DE)

(72) Inventors: Wilfried Bittner, Tsuen Wan (HK); Thomas Zimmermann, Muenchen (DE)

(73) Assignee: Robert Bosch GmbH, Stuttgart (DE)

(21) Appl. No.: 13/879,395

(22) PCT Filed: Sep. 20, 2011
(86) PCT No.: PCT/EP11/66311

§ 371 Date: Jul. 24, 2013

(30) Foreign Application Priority Data
Oct. 14, 2010 (DE) 10 2010 042 430.7

(51) Int. Cl. F21V 14/06; F21V 14/00

(52) U.S. Cl. CPC F21V 14/06; F21V 14/00
USPC 362/275; 362/311.01; 362/282; 362/311.02; 362/284

(57) ABSTRACT

The disclosure relates to an improvement of a marking light device for the emission of a standard light plane in, for example, a horizontal or a vertical direction. The aim of the marking light device is essentially to be able to produce a continuous standard light plane that has a higher accuracy than conventionally produced standard light planes. Furthermore, the disclosure relates to a method for producing a planar standard light plane by means of a marking light device.

### PRIOR ART

The present invention relates to an improvement of a marking light device for the emission of a standard light plane in, for example, a horizontal direction or a vertical direction. Such marking light devices are principally used if horizontal accuracy or vertical accuracy of a structure or of a building is intended to be set or confirmed, for example in a construction area, or if the horizontality of a ceiling, of a floor, of a design or of a part of a room is intended to be set.

Marking light devices for producing a standard light plane, which can in turn produce a line on a surface, are known from the prior art. In particular, such marking light devices are known which have an optical unit having a light source for producing a collimated light beam and having an optically deflecting element. An optically deflecting element can produce from a collimated light beam a light plane, that is to say a light pattern that uniformly radiates radially from a point—the origin of the light plane—in a plane. This takes place, in accordance with a first alternative, by expansion of the collimated light beam into a continuous light plane by the optically deflecting element, for example of a conical lens, or, in accordance with a second alternative, by rotation of a light beam about an axis of rotation by a rotating optically deflecting element, wherein the axis of rotation runs orthogonally with respect to the direction of propagation of said collimated light beam.

Embodiments in accordance with the first alternative, that is to say marking light devices having a conical lens, have been described inter alia in DE 602 02 114 T2 or JP-A-2000-18946. In the case of conical lenses, a distinction is made between convex conical lenses and concave conical lenses: the convex conical lens is substantially a cylinder-symmetrical cone whose lateral surface and base surface form an angle of 45°, wherein the lateral surface is suitable for deflecting a light beam. The concave conical lens has a central conical depression in a top surface of a substantially cylindrical body composed of light-transmissive material, wherein the lateral surface of the conical depression is suitable for deflecting a light beam.

Embodiments in accordance with the second alternative, that is to say marking light devices for producing a standard light plane by means of a rotating light beam, have been described for example in DE10116018 A1 and DE10054627 A1.

In such marking light devices, the optical unit is protected against external, in particular mechanical, influences by a cap. Said cap can have windows which consist of light-transmissive material and are arranged such that a large part of the light of the standard light plane produced passes out of the device through the windows of the cap.

Furthermore, such marking light devices have a cardan-type suspension, to be precise for orienting the standard light plane with respect to the perpendicular. The optical unit can be fixedly connected to the cardan-type suspension and be tiltable about two orthogonally intersecting axes of rotation. The cardan-type suspension can furthermore have motors, an inclination sensor (“spirit level”), and a microprocessor. The inclination sensor can determine the inclination of the standard light plane with respect to the perpendicular and communicate this to the microprocessor, which can drive the motors of the cardan-type suspension such that the standard light plane is oriented orthogonally with respect to the perpendicular. It should be noted that the relative position and orientation of the optical unit with respect to the cap, which is fixedly connected to the housing of the device, changes as a result of the orientation of the light position.

The prior art published before this application has the following problems, inter alia:

A first problem is that a cap having a plurality of windows has webs between the windows. The windows are planar and, in a manner connected by the webs, enclose the optical unit. However, said webs are light-opaque and produce a shadow, that is to say that they interrupt the standard light plane. By way of example, such a device having a substantially rotationally symmetrical cap having four windows has four webs. Such a cap can substantially have the form of a truncated pyramid. The standard light plane is therefore interrupted four times and the light line produced by the standard light plane on a surface is therefore not continuous. If precisely a location at which an interruption of the light line is present on account of the webs is essential for a measurement, the device has to be slightly rotated. This can in turn lead to a misalignment of the device, i.e. a tilting or changing of the height.

A second problem is that a beam bundle of the standard light plane impinges on the cap windows with different, location-dependent angles of incidence. This is caused, inter alia, by the fact that the housing, and thus the cap, can be situated in a manner tilted with respect to the perpendicular. In that case, as described above with regard to the cardan-type suspension, the position of the light plane changes with respect to the cap and the light plane impinges on the cap windows at different locations with different angles of incidence. The cap windows are plane-parallel layers having a higher refractive index (for quartz glass for instance n_{glass}=1.46) than air (nₐᵢᵣ=1.00). In accordance with Snell's law of refraction, a light beam or a light plane which passes through such a cap window—that is to say a plane-parallel layer—is offset in a parallel manner depending on the angle of incidence. That is to say that, on account of the dependence on the angle of incidence and on account of said location-dependent angle of incidence, the standard light plane after passing through the cap windows is no longer exactly planar, but rather disturbed. The standard light plane no longer forms a planar surface or exact plane—an obviously undesirable effect for high-precision measurement tasks.

FIG. 1A and FIG. 1B show by way of example a marking light device according to the prior art, with reference to which the problems thereof will be briefly demonstrated. This marking light device from the prior art has an optical unit having a light source 1100 and having a reflective element, a convex conical lens 1200. Furthermore, the prior art marking light device has a cap 1300 having four windows 1303. The windows 1303 each have two planar surfaces: a surface facing the optical unit, the cap entrance surface 1302, and a surface facing away from the optical unit, the cap exit surface 1304. The windows essentially form the lateral surfaces of a rotationally symmetrical truncated pyramid having a square base surface. At the lateral edges of the rotationally symmetrical truncated pyramid, the windows 1303 are connected by webs 1350. In a starting position, the central axis of the optical unit is situated on an axis of rotational symmetry of the cap 1300. In this case, the light source 1100 having a laser diode 1110 can produce a divergent light steel 1400, from which in turn a collimating lens 1120 of the light source can produce a first light beam 1401, which is oriented along the axis of rotational symmetry of the cap 1300 in the starting position. The first light beam 1401 impinges on the convex conical lens 1200, wherein an axis of rotational symmetry of the convex conical lens 1200 and a direction of propagation of the first light beam correspond. The conical lens 1200 reflects and widens the first light beam 1401 into a second light plane 1406, which lies in a planar surface that is orthogonal with respect to the first light beam 1401. The second light plane 1406 becomes—as a result of the transition through the cap entrance surfaces 1302 into the windows 1303 and as a result of the transition through the cap exit surfaces 1304—the standard light plane 1410. In the device from the prior art, the optical unit is suspended on a cardan-type suspension with pivot point 1500, wherein the pivot point 1500 is situated at the laser diode 1110. As a result, the standard light plane 1410 produced can be oriented with respect to the perpendicular, for example if a housing, including the cap, of the prior art marking light device is not optimally oriented relative to the perpendicular.

It is evident from the schematic sectional view in accordance with FIG. 1A that the optical unit is tilted—by means of the cardan-type suspension—about a first axis of rotation, which firstly runs orthogonally with respect to an axis of rotational symmetry of the cap 1300 and orthogonally with respect to an axis pointing into the plane of the drawing, and secondly runs through the pivot point 1500. On account of this tilting, the second laser plane impinges at different locations of the windows 1303 with different angles of incidence. In accordance with Snell's law of refraction, plane-parallel layers, such as the windows 1303, for example, offset light bundles in a parallel manner depending on the angle of incidence, that is to say orthogonally with respect to the direction of propagation of the light bundle and in the plane spanned by the light bundle and an orthogonal in relation to the plane-parallel layer. The offset is all the greater, the larger the angle of incidence. For this reason alone, the standard light plane does not lie in a planar surface upon a tilting of the optical unit from the starting position.

It is evident from the schematic plan view in accordance with FIG. 1B that the standard light plane 1410 is additionally interrupted by the webs 1450. Therefore, a continuous or 360° standard light plane 1410 does not arise.

### OBJECT OF THE INVENTION

The present invention is intended to provide an improved marking light device which an optically deflecting element and a cap designed according to standpoints of an optimum beam path that solves the problems described above.

### DISCLOSURE OF THE INVENTION

The invention relates to a marking light device for producing a standard light plane. The marking light device can comprise: an optical unit having a light source for producing a first light beam and having an optically deflecting element for producing a first light plane from the first light beam; and a cap for producing the standard light plane from the first light plane. The optically deflecting element can be tiltable about a first axis of rotation and a second axis of rotation. As a result of a tilting of the optically deflecting element, the standard light plane is also tilted spatially, as a result of which, for example, the standard light plane can be oriented with respect to the perpendicular after the construction of the marking light device according to the invention.

The cap of the marking light device can have a continuous window. A continuous window according to the present invention is a window having one surface and two edges, wherein the thickness of the surface can vary locally. In particular, the continuous window can be rotationally symmetrical, that is to say that the surface of the window can be a lateral surface, it not being ruled out that the thickness of the surface can vary locally. The window can consist of light-transmissive material, for example of plastic, pressed glass or cut glass. Moreover, the window can be, inter alia, an integral part of the cap or a separate part of the cap, which is either fixedly connected to the cap or removable. This embodiment is associated with the advantage that the cap has a type of 360° panoramic window without webs. As a result, a standard light plane without gaps can be produced, which can in turn produce a continuous line on surfaces of an object to be measured.

The standard light plane can be situated in a planar surface. In particular, the entire standard light plane can be situated in a planar surface for any possible tilting position of the reflective element or of the entire optical unit, that is to say without spatial-direction-dependent parallel displacement of the light bundles of the standard light plane. The standard light plane can be situated in the same planar surface as the second light plane. The standard light plane can be situated in a planar surface that runs parallel to the planar surface of the second light plane. However, the standard light plane can also be situated in a planar surface that runs in a manner tilted with respect to the planar surface of the second light plane. This embodiment is distinguished by the accuracy of its standard light plane produced. In contrast to marking light devices in accordance with the prior art, the standard light plane is actually situated in a planar surface—independently of the relative position of the reflective element with respect to the cap.

In further embodiments, the first axis of rotation, the second axis of rotation and an axis of symmetry of the cap can in each case run orthogonally with respect to one another and intersect at a pivot point. The axis of symmetry can be an axis of cylinder-symmetry, for example, if the cap is cylinder-symmetrical. However, the axis of symmetry can also be an axis of rotational symmetry if the cap has an axis of rotational symmetry. Typically, this axis of symmetry also runs through the center of gravity of the cap. The pivot point can lie substantially at a point of intersection between the first light beam and the first light plane. At the same time or alternatively, said pivot point can also lie substantially at an origin of the first light plane. In this case, the point of intersection between the first light beam and the standard light plane is not taken to mean the point of intersection of real light beams, but rather is taken to mean the point of intersection between an axis running along the direction of propagation of the first light beam and a planar surface in which the first light plane lies. Furthermore, the origin of the first light plane is taken to mean the point at which all axes of the beam bundles that produce the first light plane intersect. This embodiment entails the advantage that, as a result of advantageous positioning of the pivot point, the origin of the first light plane does not change with respect to the cap, to be precise for any possible rotational position of the reflective element or of the entire optical unit. This facilitates the design of a cap which produces from the first light plane a standard light plane situated in a planar surface. By way of example, such a cap in accordance with this embodiment can have a continuous window which is cylinder-symmetrical, whose surface facing the pivot point has at every position an identical distance between origin of the standard light plane and pivot point and which has the same thickness at every position.

In further embodiments, the pivot point can can lie within the optically deflecting element. As a result, the pivot point lies near or at the origin of the standard light plane. These embodiments entail the advantage that, as a result of advantageous positioning of the pivot point, the origin of the standard light plane does not change or hardly changes with respect to the cap, to be precise for any possible rotational position of the reflective element or of the entire optical unit. In accordance with these embodiments, too, the design of a cap which produces from the first light plane a standard light plane situated in a planar surface is facilitated. In accordance with this embodiment, such a cap can have a continuous window which is cylinder-symmetrical and which has substantially the same thickness at every position. In this case, the cap can have a form such that that surface of the continuous window of the cap which faces the pivot point and the first light plane form the same angle for any tilting position and at every location. By way of example, the surface facing the pivot point can have at every position a substantially identical distance between origin of the first light plane and pivot point. A further advantage that can additionally be afforded is that the pivot point can lie near the origin of the standard light plane rather than directly at said origin. As a result, it is possible to use a conventional cardan-type suspension for tilting the optically deflecting unit, which does not even partly block the beam path of the first light plane.

In further embodiments, the light source and the reflective optical element can be arranged fixedly with respect to one another, such that the entire optical unit is tiltable about the first axis of rotation and the second axis of rotation. These embodiments are advantageous because the arrangement of the light source relative to the reflective element does not change, as a result of which a higher degree of accuracy is achieved during the beam orientation.

In further embodiments, the continuous window of the cap can be cylinder-symmetrical. These embodiments are advantageous because they allow a simple shaping of the cap which achieves the desired effect: producing a continuous standard light plane which is situated in a planar surface.

In further embodiments, the first light plane can intersect a cap entrance surface of the continuous window, wherein at each point of intersection between the light plane and the cap entrance surface, independently of a tilting position of the optically deflecting element, substantially a constant angle is formed between the light plane and the cap entrance surface. This embodiment is advantageous because it is thereby possible to use a cap having a continuous cap window which has the same thickness at every location. Each beam bundle of the first light plane is offset substantially by the same length and a standard light plane which lies in a planar surface arises.

In further embodiments, the standard light plane can be substantially collimated with respect to a first axis running orthogonally with respect to the first standard light plane. These embodiments are advantageous because the standard light plane expands as little as possible in the spatial direction that is important for the measurement, which is in turn associated with a higher accuracy of the measurement by means of the standard light plane.

In further embodiments, the continuous window of the cap can have a locally variable thickness and/or can have a locally variable refractive index. By means of the locally variable thickness and the locally variable refractive index, by way of example, the standard light plane can be produced from the first light plane such that it lies in a planar surface and that it is substantially collimated with respect to a first axis running orthogonally with respect to the first standard light plane.

In further embodiments, the optically deflecting element can be embodied as a concave conical lens. The concave conical lens can have a conical depression in a top surface of a substantially cylindrical lens body composed of light-transmissive material, wherein the lateral surface of the conical depression, the concave conical lens conical surface, is suitable for reflecting a light beam. In this case, the concave conical lens can have the following: a concave conical lens entrance surface, the base surface of the cylindrical lens body, for producing a second light beam from the first light beam; the concave conical lens conical surface for producing a second light plane from the second light beam; and a concave conical lens exit surface, the lateral surface of the lens body, for producing a first light plane from the second light plane. Furthermore, the continuous window of the cap can have the following: a cap entrance surface, the surface facing the concave conical lens, for producing a cap light plane from the first light plane; and a cap exit surface, the surface facing away from the concave conical lens, for producing the standard light plane from the cap light plane. Advantageously, firstly, the concave conical lens entrance surface, the concave conical lens conical surface, the concave conical lens exit surface, the cap entrance surface and the cap exit surface can have forms (for example planar, convex, concave or any other beam-shaping form) and, secondly, the concave conical lens and the continuous window of the cap can have refractive indices such that the standard light plane is substantially collimated with respect to a first axis running orthogonally with respect to the first standard light plane, and such that the standard light plane is substantially situated in a planar surface.

In further embodiments, the optically deflecting element can be embodied as a convex conical lens. The convex conical lens can substantially be a cylinder-symmetrical cone whose lateral surface, a convex conical lens lateral surface, and whose base surface form an angle of 45°, wherein the lateral surface is suitable for reflecting a light beam. Typically, the convex conical lens is arranged fixedly with respect to the rest of the components of the optical unit. In order to produce the standard light plane which is continuous, that is to say uninterrupted over 360°, the convex conical lens, in contrast to the concave conical lens, can be connected to the rest of the optical unit via a transparent element. According to the present invention, said transparent element should be regarded as part of the optically deflecting element and can be configured as a hollow cylinder without base and top surfaces. In this case, the convex conical lens can have the following: a convex conical lens conical surface for producing a third light plane from the first light beam; a convex conical lens entrance surface, the inner surface of the hollow cylinder, for producing a second light plane from the third light plane; and a convex conical lens exit surface, the outer surface of the hollow cylinder, for producing a first light plane from the second light plane. In this case, the continuous window of the cap can have the following: a cap entrance surface, the surface facing the convex conical lens, for producing a cap light plane from the first light plane; and a cap exit surface, the surface facing away from the convex conical lens, for producing the standard light plane from the cap light plane. Advantageously, firstly the convex conical lens conical surface, the convex conical lens entrance surface, the convex conical lens exit surface, the cap entrance surface and the cap exit surface can have forms (for example planar, convex, concave or any other beam-shaping form) and, secondly, the convex conical lens and the continuous window of the cap can have a refractive index such that the standard light plane is substantially collimated with respect to a first axis running parallel to an axis of cylinder-symmetry of the conical lens, and such that the standard light plane is substantially situated in a planar surface.

In further embodiments, the reflective element can be embodied as a pentaprism. In this case, the pentaprism can be rotatable about an axis of rotation for producing a first light plane from the first light beam, wherein the axis of rotation runs coaxially with respect to the first light beam. In this case, the continuous window of the cap can have the following: a cap entrance surface for producing a cap light plane from the first light plane; and a cap exit surface for producing the standard light plane from the cap light plane. Advantageously, firstly, the pentaprism, the cap entrance surface and the cap exit surface can have forms (for example planar, convex, concave or any other beam-shaping form) and, secondly, the pentaprism and the continuous window of the cap can have a refractive index such that the standard light plane is substantially collimated with respect to a first axis running parallel to the first light beam, and such that the standard light plane is substantially situated in a plane.

In further embodiments, the optically deflecting element can produce a first light plane, which diverges with respect to a first axis running orthogonally with respect to the first standard light plane. The cap can then produce from the first light plane the standard light plane which is substantially collimated with respect to the first axis. These embodiments entail the advantage that a standard light plane with an optimum beam shape can be produced with the aid of the reflective element and the cap. In particular, the divergence of the standard light plane with respect to the first axis can be minimized by an optimum beam shape.

In further embodiments, the light source can have a light diode for producing a divergent light beam and a lens for collimating the divergent light beam into a first light beam. Said first light beam can be divergent or convergent or collimated.

In further embodiments, the optical unit can be mounted in a manner tiltable about the pivot point by means of a cardan-type suspension.

In further embodiments, the cardan-type suspension can have an inclination sensor for determining the inclination of the optical unit with respect to the perpendicular and motors for setting the inclination of the optical unit with respect to the perpendicular. These embodiments entail the advantage that the optical unit or the second light plane and the standard light plane can always be oriented with respect to the perpendicular.

### DRAWING

With reference to the drawings, the invention is explained thoroughly below by way of example on the basis of exemplary embodiments. The description, the associated figures and the claims contain numerous features in combination. A person skilled in the art will also consider these features, in particular also the features of different exemplary embodiments, individually and combine them to form expedient further combinations. In the figures:

FIG. 1A shows a schematic sectional view of a prior art marking light device;

FIG. 1B shows a schematic plan view of a prior art marking light device;

FIG. 2 shows an isometric view of a preferred embodiment of a marking light device according to the present invention;

FIG. 3 shows an isometric view of a preferred reflective element, in particular a concave conical lens, according to the present invention;

FIG. 4 shows an isometric view of a preferred cap according to the present invention;

FIG. 5 shows a schematic sectional view of the preferred embodiment of the marking light device according to the present invention;

FIG. 6 shows a schematic sectional view of one embodiment of a marking light device according to the present invention;

FIG. 7 shows a schematic sectional view of one embodiment of a marking light device according to the present invention; and

FIG. 8 shows a block diagram of the control system of an embodiment of a marking light device according to the present invention.

### DESCRIPTION OF THE EXEMPLARY EMBODIMENTS

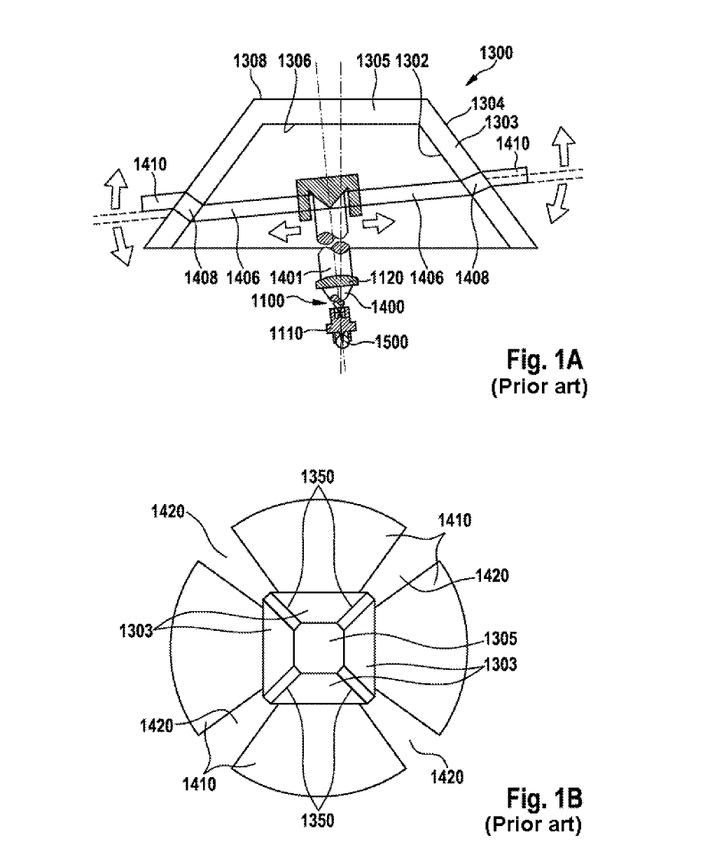

The present invention provides a marking light device for producing a standard light plane 410 comprising an optical unit, having an optically deflecting element 200 and a light source 100, and comprising a cap 300, which solves the problems illustrated in FIGS. 1A and 1B.

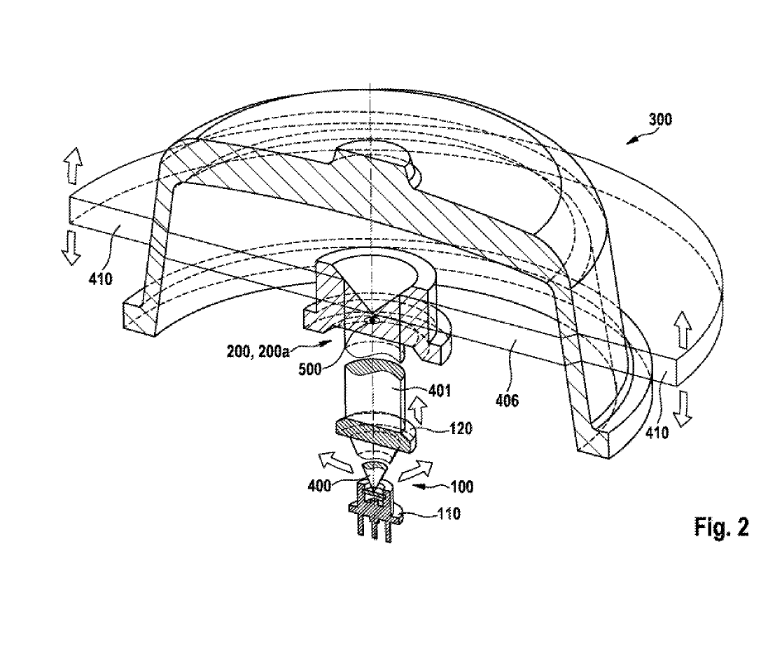

FIG. 2 shows an isometric view of a central section through a preferred embodiment of a marking light device according to the present invention. This preferred embodiment is suitable for producing a standard light plane 410 and comprises a cylinder-symmetrical cap 300 and an optical unit having a light source 100 and having an optically deflecting element 200, the optically deflecting element 200 is configured as a concave conical lens 200a. The light source 100 in turn comprises a laser diode 110 for producing a divergent light beam 400 and a collimator lens 120 for collimating the divergent light beam 400 into a collimated first light beam 401. The light source 100 is designed such that the first light beam 401 impinges orthogonally on a base surface 202a of the concave conical lens 200a. The concave conical lens produces from the first light beam 401 a first light plane 406, which in turn impinges on the cap 300. The cap 300 produces the standard light plane 410 from the first light plane 406. The optical unit, that is to say the light source 100 and the optically deflecting element 200, is mounted in a manner tiltable about a pivot point 500 by means of a cardan-type suspension, that is to say that the optical unit is tiltable about two axes: a first axis of rotation and a second axis of rotation, which intersect orthogonally at the pivot point 500. Both axes of rotation are furthermore orthogonal with respect to an axis of cylinder-symmetry of the cap 300. The pivot point is situated directly below an origin of the first light plane 406, such that, upon a tilting of the optical unit about said pivot point 500, the origin of the first light plane 406 substantially does not move or moves only very little with respect to the cap 300. The pivot point 500 is situated within the optically deflecting element 200, that is to say within the concave conical lens 200a and below the first light plane 406.

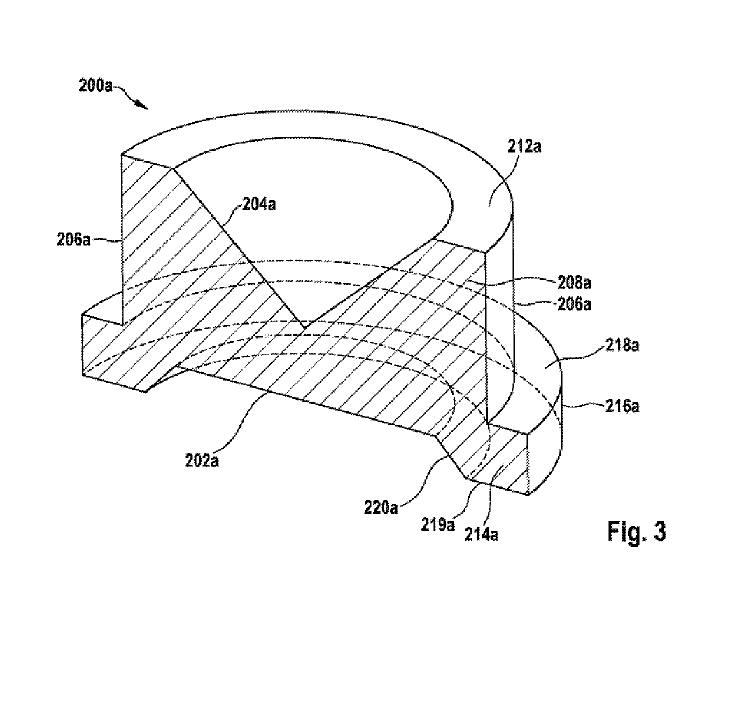

FIG. 3 shows an isometric view of a central section through the optically deflecting element of the preferred embodiment of a marking light device. This concerns the concave conical lens 200a. The concave conical lens 202a is produced from a thermoplastic synthetic resin material, which is light-transmissive and has a constant refractive index, with the aid of an injection-molding device. The concave conical lens 200a is substantially cylinder-symmetrical and has a main cylinder body 208a having a base surface 202a, a top surface 212a and a lateral surface 206a. In this case, the main cylinder body has a flange 214a at the edge between base surface 202a, the concave conical lens entrance surface 202a, and lateral surface 206a, the concave conical lens exit surface 206a. The flange 214a is configured like a ring extending both over the lateral surface 206a and over the base surface 202a. The flange 214a is delimited by side surfaces 218a and 219a running parallel to the base surface 202a and the top surface 212a. Furthermore, the flange 214a is delimited by an outer surface 216a, which in turn runs parallel to the lateral surface 206a. Finally, the flange 214a also has an oblique, tapering surface 220a, which connects the side surface 219a to the base surface 202a. The flange 214a serves for fixing the concave conical lens 200a to the optical unit. The top surface 212a has a cylinder-symmetrical depression, substantially in the form of a cone. The surface of the cylinder-symmetrical depression, the concave conical lens conical surface 204a, has the form of a cone envelope. In this case, a reflective film is is formed on the concave conical lens conical surface 204a, such that the concave conical lens conical surface 204a forms a reflective surface. The concave conical lens conical surface 204a has an aperture angle that is substantially 90°, such that a first light beam that impinges on the concave conical lens entrance surface 202a centrally and parallel to the axis of cylinder-symmetry of the concave cone 200a is deflected by the concave conical lens entrance surface 202a, the concave conical lens surface 204a and the concave conical lens exit surface 206a into a first light plane, which is situated orthogonally with respect to the first light beam.

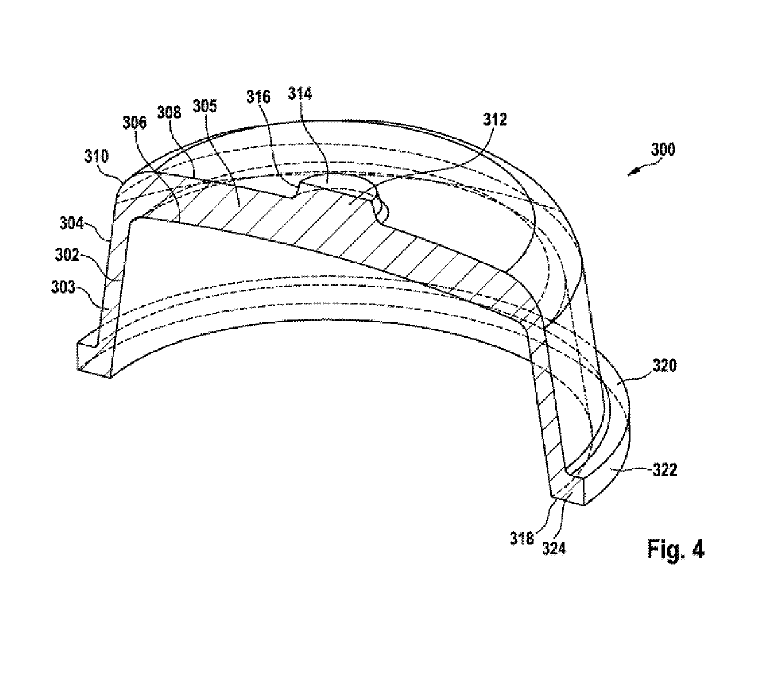

FIG. 4 shows an isometric view of a central section through the cap 300 of the preferred embodiment of a marking light device. The cap 300 is produced from a thermoplastic synthetic resin material, which is light-transmissive and has a constant refractive index, with the aid of an injection-molding device. The cap 300 is substantially cylinder-symmetrical and has a tapering side wall 303, the continuous window 303, wherein said side wall is open on a wide side and closed by a top surface 305 on a tapered side. The continuous window 303 is an integral part of the cap 300 and has an inner surface 302, the cap entrance surface 302, and an outer surface 304, the cap exit surface 304. The top surface 305 has an inner surface 306 and an outer surface 308. The edge between the outer surfaces 304 and 308 is beveled by an oblique outer surface 310. The top surface 305 furthermore has a construction 312 substantially having the form of a flat cylinder having top surface 314 and lateral surface 316. The side wall 303 has at the open end a flange 318 substantially having the form of a ring. The flange 318 terminates flush with the open end of the side wall 303, but extends over the outer surface 304. In this case, the flange 318 has the side surfaces 320 and 324 and the outer surface 322. The flange 318 serves for fixing the cap 300 to the housing of the marking light device.

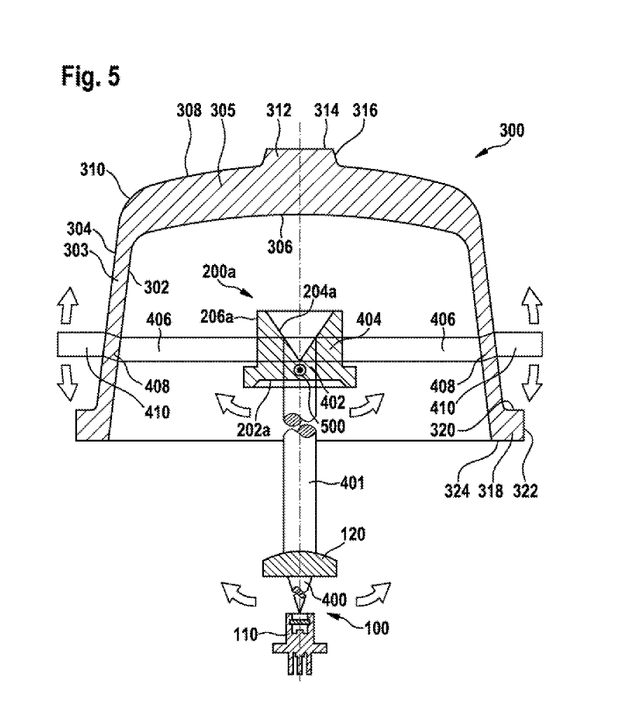

FIG. 5 shows a schematic sectional view of the preferred embodiment of the marking light device. The laser diode 110 of the light source 100 produces a divergent light beam 400 and the collimating lens of the light source 100 produces from the divergent light beam 400 a first light beam 401, which is collimated. The collimated light beam impinges on the concave conical lens entrance surface 202a of a concave conical lens 200a. A second light beam 402 is thereby produced within the concave conical lens 202a, but said second light beam has the same direction of propagation as the first light beam 401, because the first light beam 401 impinges on the concave conical lens entrance surface 202a orthogonally and centrally. The concave conical lens conical surface 204a deflects the second light beam 402 into a second light plane 404. The second light plane 404 lies in a plane situated orthogonally with respect to the first light beam 401 and the second light beam 402 and an axis of symmetry of the concave conical lens 200a. The second light beam 404 emerges from the concave conical lens 200a through the concave conical lens exit surface 206a, in particular orthogonally, and thus produces a first light plane 406, which has the same direction of propagation as the second light plane 404. Said first light plane 404 in turn impinges on the cap entrance surface 302 of the cap 300, as a result of which a cap light plane 408 is produced within the cap 300, which cap light plane in turn emerges through the cap exit surface 304 and produces the standard light plane 410. The cap entrance surface 302 and the cap exit surface 304 have forms such that the standard light plane 410 is substantially collimated with respect to a first axis running orthogonally with respect to the first standard light plane 410, and such that the standard light plane is substantially situated in a planar surface running parallel to the first light plane 406. In particular, the first light plane 406 impinges on the cap entrance surface 302 substantially at the same angle in any tilting position of the optical unit and the cap light plane 408 impinges on the cap exit surface 304 substantially at the same angle in any tilting position of the optical unit. As a result, the offset of the standard light plane 410 with respect to the first light plane 406 is substantially constant for any tilting position and any spatial direction and the standard light plane 410 substantially lies in a planar surface.

In the preferred embodiment of a marking light device according to the present invention, the light source 100 and the reflective optical element 200 are arranged fixedly with respect to one another, such that the entire optical unit is tiltable about the first axis of rotation and the second axis of rotation. For this purpose, the optical unit is suspended by means of a cardan-type suspension that allows a tilting of the optical unit with respect to the cap 300 about the first and second axes of rotation by up to +−15° in each case.

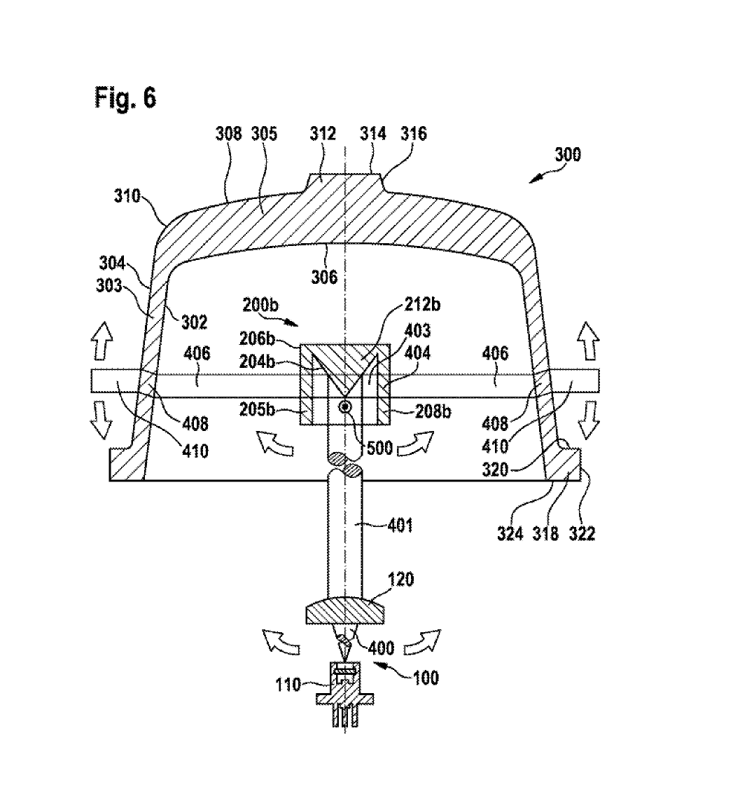

FIG. 6 shows a schematic sectional view of an alternative embodiment of a marking light device according to the present invention. The latter differs from the preferred embodiment in that the optically deflecting element 200 is a cylinder-symmetrical convex conical lens 200b. The convex conical lens 200b has a hollow cylinder 208b. The hollow cylinder 208b is open on one side and closed by means of a top surface 212b on the other side. The top surface 212b is planar toward the outside, but has a convex cone toward the inside. Said convex cone is delimited by the convex conical lens conical surface 204b. In this case, a reflective film is is formed on the convex conical lens conical surface 204b, such that the convex conical lens conical surface 204b forms a reflective surface. The convex conical lens conical surface 204b has an aperture angle that is substantially 90°, such that a first light beam, which impinges on the convex conical lens conical surface 204b centrally and parallel to the axis of cylinder-symmetry of the convex conical lens 200b, is deflected by the convex conical lens conical surface 204b into a third light plane 403 situated orthogonally with respect to the first light beam 401. The third light plane 403 enters into the hollow cylinder 208b orthogonally through a convex conical lens entrance surface 205b and produces a second light plane 404, which leaves the hollow cylinder 208b in turn orthogonally through a convex conical lens exit surface 206b and produces a first light plane 406. The pivot point is situated directly below an origin of the first light plane 406, such that, upon a tilting of the optical unit about said pivot point 500, the origin of the first light plane 406 substantially does not move or moves only very little with respect to the cap 300. The pivot point 500 is situated within the hollow cylinder 208b, that is to say within the convex conical lens 200b, and directly below the first light plane 406. The hollow cylinder 208b can be an integral or a separate part of the convex conical lens 200b. The hollow cylinder 208b and the entire convex conical lens can consist of a transparent material, for example, plastic, pressed glass or cut glass. Alternatively, the convex cone delimited by the convex conical lens conical surface 204b can consist of reflective material, such as aluminum, while the hollow cylinder 208b consists of said transparent material.

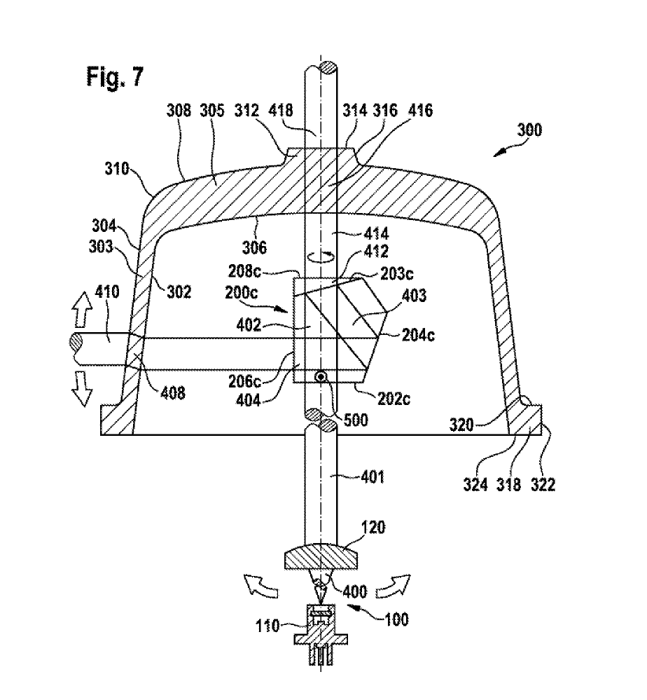

FIG. 7 shows a schematic sectional view of an alternative embodiment of a marking light device according to the present invention. The latter differs from the preferred embodiment in that the optically deflecting element 200 is a rotating pentaprism 200c. The pentaprism 200c has: a pentaprism entrance surface 202c for producing a second light beam 402 from the first light beam 401; a first reflective surface 203c for producing a third light beam 403 from the second light beam 402; a second reflective surface 204c for producing a fourth light beam 404 from the third light beam 403; and a first pentaprism exit surface 206c for producing a fifth light beam 406 from the fourth light beam 404. A first light plane 406 is produced by rotation of the pentaprism 200c about an axis of rotation running along the direction of propagation of the first light beam 401. This alternative embodiment furthermore differs in that the optically deflecting element 200, the pentaprism 200c, produces from the the first light beam 401 not only a first light plane 406 but also a light beam 414 that leaves the pentaprism along the direction of propagation of the first light beam 401 and impinges on the inner surface of the cap cover 305. As a result, a light beam 416 is produced which leaves the cap 300 through the top surface 314 of the cap construction 312. As a result, the marking light device can produce a standard light beam 418 running orthogonally with respect to the standard light plane and through the origin of the standard light plane. For this purpose, a reflective film is formed on the first reflective surface 203c, such that the first reflective surface forms a surface which reflects light beams to the extent of 70% and a surface which transmits light beams to the extent of 30%. Furthermore, for this purpose there is attached to the pentaprism 200c a triangular prism having a triangle as base surface and having the same refractive index as the pentaprism 200c. A part of the second light beam 402 is therefore transmitted at the first reflective surface 203c and produces a light beam 412 in the triangular prism. This light beam 412 in turn impinges orthogonally on the surface 208c of the triangular prism and produces light beam 414. This alternative embodiment can also have a further optical element at the optically deflecting element in order to produce standard light patterns instead of the standard light beam 418. One example of such a further optical element is a diffractive optical element (DOE). Other optical elements, such as refractive optical elements, for example, can likewise be used. The pentaprism can consist of plastic, pressed glass or cut glass.

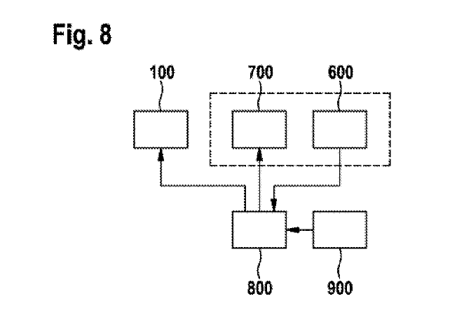

FIG. 8 shows a block diagram of the control system of the preferred embodiment of a marking light device according to the present invention. The optical unit is mounted in a manner tiltable about the pivot point 500 by means of a cardan-type suspension, wherein the cardan-type suspension has an inclination sensor 600 for determining the inclination of the optical unit with respect to the perpendicular and motors 700 for setting the inclination of the optical unit with respect to the perpendicular. The inclination sensor can communicate the the inclination of the optical unit with respect to the perpendicular to a microprocessor 800. The microprocessor is configured such that, from the communicated inclination, can communicate a control command to the motors, which causes the motors to tilt the optical unit about the pivot point 500 such that the optical unit is oriented with respect to the perpendicular. By way of example, in this embodiment, the optical unit can always be automatically oriented with respect to the perpendicular such that the standard light plane 410 is always orthogonal with respect to the perpendicular. Examples of inclination sensors 600 according to the invention are microelectromechanical systems (MEMS). The microprocessor 800 can be configured via a user interface 900.

In an alternative embodiment, it is also possible for the optical unit on a cardan-type suspension not to be oriented with respect to the perpendicular by means of motors and an electronic inclination sensor. Instead, the optical unit can be oriented with respect to the perpendicular in a freely oscillating manner by means of an advantageous weight distribution. This process can be accelerated by the cardan-type suspension having an eddy current brake.

1. A marking light device for producing a standard light plane, comprising:
an optical unit including (i) a light source configured to produce a first light beam, and (ii) an optically deflecting element configured to produce a first light plane from the first light beam; and
a cap configured to produce the standard light plane from the first light plane, including a window, and the standard light plane being situated in a planar surface.

2. The marking light device as claimed in claim 1, wherein the optically deflecting element is tiltable about a first axis of rotation and a second axis of rotation.

3. The marking light device as claimed in claim 2, wherein:
the first axis of rotation, the second axis of rotation and an axis of symmetry of the cap in each case run orthogonally with respect to one another and intersect substantially at a pivot point, and
the pivot point lies within the optically deflecting element.

4. The marking light device as claimed in claim 2, wherein the light source and the optically deflecting element are arranged fixedly with respect to one another, such that the entire optical unit is tiltable about the first axis of rotation and the second axis of rotation.

5. The marking light device as claimed in claim 1, wherein:
the window is a continuous window, and
the continuous window is cylinder-symmetrical.

6. The marking light device as claimed in claim 5, wherein:
the first light plane intersects a cap entrance surface of the continuous window, and
at each point of intersection between the light plane and the cap entrance surface, independently of a tilting position of the optically deflecting element, substantially a constant angle is formed between the first light plane and the cap entrance surface.

7. The marking light device as claimed in claim 1, wherein:
the window is a continuous window, and
the continuous window has at least one of a locally variable thickness and a locally variable refractive index.

8. The marking light device as claimed in claim 1, wherein the standard light plane is substantially collimated with respect to a first axis running orthogonally with respect to the first standard light plane.

9. The marking light device as claimed in claim 1, wherein the optically deflecting element includes one of (i) a concave conical lens, (ii) a convex conical lens, and (iii) a pentaprism.

10. The marking light device as claimed in claim 1, wherein:
the optically deflecting element produces a second light plane, which diverges with respect to a first axis running orthogonally with respect to the first standard light plane, and
the cap produces the standard light plane from the second light plane, said standard light plane being substantially collimated with respect to the first axis.

11. The marking light device as claimed in claim 1, wherein the light source includes a light diode configured to produce a divergent light beam and a lens configured to collimate the divergent light beam into a first collimated light beam.

12. The marking light device as claimed in claim 11, wherein the first collimated light beam is divergent or convergent or collimated.

13. The marking light device as claimed in claim 3, wherein the optical unit is mounted in a manner tiltable about the pivot point by a cardan-type suspension apparatus.

14. The marking light device as claimed in claim 13, wherein the cardan-type suspension apparatus includes (i) an inclination sensor configured to determine an inclination of the optical unit with respect to a perpendicular, and (ii) motors configured to set the inclination of the optical unit with respect to the perpendicular.

15. A method for producing a standard light plane, with a marking light device, comprising:
producing a light beam with a light source of an optical unit;
deflecting the light beam with an optically deflecting element to produce a first light plane from the light beam;
passing the first light plane through a window of a cap to produce the standard light plane from the first light plane;
modifying the light beam produced by the light source and deflected by the optically deflecting element prior to the light beam passing through the window,
wherein the light beam is modified by the optically deflecting element, such that a standard light plane which forms a planar surface arises after beam deflection at the window.
